(19) United States
(12) Patent Application Publication
(10) Pub. No.: US 2003/0141607 A1
(43) Pub. Date: Jul. 31, 2003

(54) Method for producing a data memory

(76) Inventors: John Leiber, Hamburg (DE); Bernhard Mussig, Seevetal (DE); Stefan Stadler, Hamburg (DE)

Correspondence Address: Nixon & Vanderhye, 8th Floor, 1100 North Glebe Road, Arlington, VA, 22201-4714, US

(21) Appl. No.: 10/275,916

(22) PCT Filed: May 22, 2001
(86) PCT No.: PCT/EP01/05874

(30) Foreign Application Priority Data
Jun. 7, 2000 (DE) 10028086.2

(51) Int. Cl. B29D 17/00

(52) U.S. Cl. 264/1.33

(57) ABSTRACT

In a method of producing a data storage medium with an optically writeable and readable information carrier which comprises a polymer film whose refractive index can be altered locally by heating, to the polymer film being assigned an absorber which is set up so as at least partly to absorb a write beam and to emit the generated heat at least partly, locally, to the polymer film, first of all a storage film (11) is prepared. The storage film (11) comprises the polymer film (34) and the absorber (35) assigned to the polymer film (34). Subsequently, the storage film (11) is adapted to the geometry provided in the data storage medium.

The invention relates to a method of producing a data storage medium with an optically writeable and readable information carrier.

DE 298 16 802 U1 discloses a data storage medium with an optically writeable and readable information carrier which comprises a polymer film whose refractive index can be altered locally by heating. When the polymer film is heated locally by means of a write beam, the change in refractive index results in a change in the reflecting power (reflectivity) at the site under consideration. This can be utilized for the purpose of storing information. The information is read using a read beam which is reflected to a greater extent by sites having increased reflectivity, and this can be measured in order to detect the information. The polymer film, which is composed for example of polypropylene (the material for the product marketed by Beiersdorf AG under the designation “tesafilm kristallklar”), may be pretensioned (drawn) in both surface directions during production, as a result of which a high inherent energy is stored in the material. On local heating by the write beam, a sharp change in material (compression) occurs as a result of reverse deformation in the case of this kind of embodiment of the polymer film, the refractive index changing in the manner desired. In the case of the existing data storage medium there may be an absorber (for example a dye) in an adhesion layer adjacent to the polymer film, said absorber preferentially absorbing the write beam and emitting the generated heat locally to the polymer film. By means of an absorber it is possible to achieve a sufficiently large change in the refractive index (for example, a change of approximately 0.2) even with a relatively low write beam intensity.

The polymer film of the existing data storage medium is wound spirally in a plurality of plies on a winding core, with an adhesion layer disposed between adjacent polymer film plies. By focusing the write beam or read beam it is possible to write information into, or read it from, a preselected ply of the information carrier in a targeted way. The winding core may be optically transparent and may in its central region have a recess which serves to accommodate the read/write device of a data drive. The read/write device is moved relative to the data storage medium, while the data storage medium is stationary, so that there is no need to balance the data storage medium to take account of a rapid rotational motion.

As regards the production of the existing data storage medium, it is a disadvantage that the polymer film cannot be used directly as storage film but that instead, first of all, in a separate, complex step, the adhesion layer comprising the absorber must be applied to the polymer film. In order to introduce a sufficient amount of absorber, moreover, the adhesion layer is required to be undesirably thick, exceeding the layer thickness required for achieving adequate bond strength, and impairing the optical transparency of the data storage medium.

It is an object of the invention to provide a method of producing a data storage medium of the type specified at the outset which can be implemented more cost-effectively and with less complexity and which yields data storage media of high quality.

This object is achieved by a method having the features of claim 1. Advantageous embodiments of the invention follow from the dependent claims.

The method of the invention serves to produce a data storage medium with an optically writeable and readable information carrier which comprises a polymer film whose refractive index can be altered locally by heating. To the polymer film, there is assigned an absorber which is set up so as at least partly to absorb a write beam and to emit the generated heat at least partly, locally, to the polymer film. In accordance with the invention, the method involves preparing a storage film comprising the polymer film and the absorber assigned to the polymer film. Subsequently the storage film is adapted to the geometry provided in the data storage medium.

For the production process it is of advantage, with a view to workrate, for example, if first of all a storage film is manufactured in which the polymer film and the absorber assigned to the polymer film are integrated. In particular, the absorber may be provided in such an amount per unit area of the storage film that a desired optical density of the storage film can be set without affecting the thickness of any adhesion layer. In absorption, the optical density is the product of the extinction coefficient (concentration-independent material constant) of the absorber, its concentration, and the layer thickness through which the radiation passes, and is a variable well suited to characterizing the absorption behavior. At the light wavelength of a write beam, the optical density is preferably situated in a range from 0.1 to 0.3 for one ply of the storage film, but may also be smaller or larger.

For the preparation of the storage film there are a number of possibilities.

In one embodiment of the method, during preparation of the storage film the polymer film is extruded together with a layer which is disposed on the polymer film and comprises absorber. Apart from the absorber, the layer comprising absorber preferably comprises a binder, in order to adhere to the polymer film. This method has the advantage that the absorber is separate from the polymer film and is therefore unable to have any more than at best an insubstantial influence on its properties. It is also possible to use absorbers which cannot be distributed homogeneously in the polymer for the polymer film. When the layer comprising absorber is heated locally by means of a write beam, the heat is passed on in particular into the adjacent surface zone of the polymer film, so that the information is stored primarily in this surface zone.

In an alternative embodiment of the method, during preparation of the storage film the absorber is admixed to the polymer for the polymer film and then a unit comprising polymer film and absorber is extruded from the absorber-comprising polymer. In this case, therefore, the storage film is a polymer film which in addition to the base polymer further comprises absorber. This method has the advantage that the absorber is in general distributed uniformly in the polymer and therefore emits the heat released on absorption of a write beam directly to the polymer. The information can therefore be deposited everywhere within the storage film; that is, for example, as viewed in the direction of the thickness of the storage film, even in the center, and not just at the interface between a polymer film and an absorber layer. Since the absorber is admixed to the polymer, it is possible to achieve a high level of homogeneity in the distribution of the absorber. However, absorber dyes (see below) are also required which withstand the conditions prevailing during extrusion (for example, high temperature, high pressure).

In another alternative embodiment of the method, preparation of the storage film involves first extruding the polymer film, after which the absorber is introduced into the polymer film by a diffusion process. This variant also makes it possible to use absorber dyes whose temperature stability is less. In principle, the advantages are the same as in the case of extrusion of the storage film from a mixture of polymer and absorber. However, with a diffusion process, it is generally not possible to achieve readily such good homogeneity in the distribution of the absorber within the polymer as in the case of the mixing process illustrated previously.

In one type of diffusion process, the polymer film is swollen in a solution comprising the absorber and then the solvent is evaporated.

In another type of diffusion process, the absorber is transferred to the gas phase and the polymer film is exposed to a gas which comprises the absorber. The molecules of the absorber diffuse into the polymer film. This variant is particularly suitable for absorbers which sublime, i.e., pass directly from the solid aggregate state to the gaseous state, such as iodine, for example.

An example of a suitable polymer for the polymer film is polypropylene, although other materials are also conceivable. In order for the storage film to comprise a polymer film of biaxially oriented polymer (for example, polypropylene), it is possible in the case of the methods elucidated previously in which the storage film is prepared with polymer and absorber by extrusion to subject the extrudate to biaxial orientation following extrusion. If, on the other hand, the absorber is introduced into the polymer film by a diffusion process, the polymer film may be biaxially oriented before or after this diffusion process is implemented.

The storage film or polymer film is biaxially oriented by being pretensioned in two directions, perpendicular to one another, within its plane in the course of production. This results in a high energy density being stored in the film material. By depositing a relatively small amount of energy per unit area by means of a write beam it is then possible to obtain a sharp change in material (for example, a compression of material) as a result of reverse deformation, which results in a local change in the refractive index and in a change in the optical path length in the material. The change in the refractive index in the region heated locally by a write beam is preferably in the order of magnitude of 0.2. This leads to a change in the local reflectivity, which can be detected well by means of a read beam.

Suitable absorbers include dyes such as, for example, Disperse Red 1, anthraquinone dyes or indanthrene dyes. Mixtures of different absorber dyes are also conceivable. Anthraquinone dyes and indanthrene dyes have a higher temperature stability than Disperse Red 1 and therefore offer advantages if the storage film is prepared by way of an extrusion process.

With the method of the invention it is possible in principle to produce a data storage medium wherein the storage film is disposed in a single ply. In one preferred embodiment of the invention, however, the storage film is disposed in a plurality of plies through which information can be written to a preselected storage film ply or read from a preselected storage film ply. As a result, a high storage density is achieved. By focusing the read beam and the write beam of a read/write device, such as is known in principle, for example, from DVD technology, it is possible to write information into and, respectively, read it from this storage film ply in a targeted way. During the write operation, the write beam is defocused in the storage film plies adjacent to the relevant storage film ply, so that the adjacent storage film plies undergo only slight local heating and the stored information is not altered in them.

One possibility of giving the storage film a multi ply arrangement consists in winding a coherent storage film spirally. The storage film is preferably wound onto a central, optically transparent core which is disposed to accommodate a read/write device of a drive attuned to the data storage medium. A data storage medium produced in this way can be used in a drive in which a read and/or write beam moves in the interior of the core while the data storage medium is stationary. The data storage medium need not, therefore, be balanced to take account of a rapid rotary movement.

Preferably, an adhesion layer is disposed between adjacent storage film plies in order to fix the storage film plies to one another. The adhesion layer can be applied to the storage film, for example, following the preparation of the storage film and before or during the adaptation of the storage film to the geometry provided in the data storage medium. The refractive index of the adhesion layer differs preferably only slightly from the refractive index of the storage film, in order to minimize disruptive reflections of a read beam or of a write beam at a boundary between a storage film ply and an adjacent adhesion layer. It is particularly advantageous if the difference in the refractive indices is less than 0.005. Any difference in refractive indices that does exist, however, may be utilized for the purpose of formatting the data storage medium.

The invention is elucidated in more detail below with reference to examples. The drawings show in

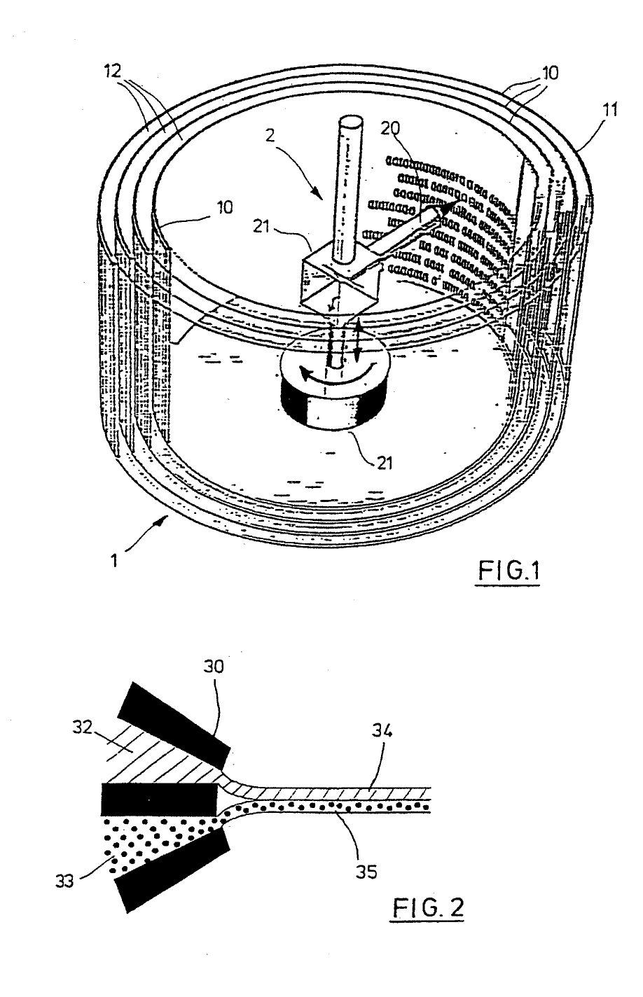

FIG. 1 a data storage medium produced by the method of the invention, comprising a spirally wound storage film, in diagrammatic perspective representation, with parts of a drive attuned to the data storage medium being disposed in a recess in the central region of the data storage medium, and

FIG. 2 a diagrammatic representation of an extruder head with which the storage film of the data storage medium from FIG. 1 is extruded.

FIG. 1 shows in diagrammatic representation a data storage medium 1 and a read/write device 2 of a drive attuned to the data storage medium 1. The data storage medium 1 comprises a number of plies 10 of a storage film 11 which serves for information storage and is wound spirally around an optically transparent core. For the sake of clarity the core is not depicted in FIG. 1; it is located within the innermost ply 10. For improved illustration, the individual plies 10 of the storage film 11 are shown in FIG. 1 as concentric rings, although the plies 10 are formed by spiral winding of the storage film 11. Between each pair of adjacent plies 10 of the storage film 11 there is an adhesion layer 12; the adhesion layers 12 are all coherent and overall likewise have a spiral course. For reasons of clarity, the adhesion layers 12 have been drawn in FIG. 1 in an enlarged thickness which is not to scale.

In the example, the storage film 11 is composed of biaxially oriented polypropylene with an absorber layer which comprises an absorber dye, as illustrated in more detail later on below with reference to FIG. 2. In the example the storage film 11 has a total thickness of 35 μm; other thicknesses in the range from 10 μm to 100 μm or even thicknesses lying outside of this range are likewise conceivable. The adhesion layers 12 are free from gas bubbles and in the example are composed of acrylate adhesive with a thickness of 5 μm, preferred layer thicknesses being situated between 1 μm and 40 μm. In the example the data storage medium 1 contains twenty plies 10 of the storage film 11 and has an external diameter of approximately 30 mm. Its height is 19 mm. A different number of plies 10, or different dimensions, are likewise possible. The number of winds or plies 10 may, for example, be between ten and thirty, but may also be greater than thirty.

The read/write device 2 disposed in a recess in the central region of the core of the data storage medium 1 contains a read/write head 20 which can be moved backward and forward axially and rotated in the directions of the arrows that have been drawn in, by means of a mechanism 21. The read/write head 20 comprises optical elements by means of which a light beam (of wavelength, for example, 630 nm or 532 nm) produced by a laser, which is not shown in FIG. 1, may be focused onto the individual plies 10 of the storage film 11. Since the read/write head 20 is moved by means of the mechanism 21, it is able to scan fully all of the plies 10 of the data storage medium 1. In the example the data storage medium 1 is stationary. Consequently, it does not need to be balanced to take account of a high rotational speed (and there is also no need for it to be unwound or rewound), unlike the read/write head 20. For the sake of clarity, the elements provided for balancing the read/write head 20 have not been shown in FIG. 1. The laser mentioned is located outside of the read/write head 20 and is stationary; the laser beam is guided into the read/write head 20 by way of optical elements.

For the purpose of storing or writing information in or to the data storage medium 1, the laser in the example is operated with a beam power of approximately 1 mW. The laser beam serves here as a write beam and is focused onto a preselected ply 10 of the storage film 11, in such a way that the beam spot is smaller than 1 μm, the light energy being introduced in the form of short pulses of approximately 10 μs in duration. The energy of the write beam is absorbed in the beam spot, promoted by the absorber in the storage film 11, leading to local heating of the storage film 11 and hence to a local change in the refractive index and in the reflectivity.

In order to read stored information from the data storage medium 1, the laser is operated in continuous wave mode (CW mode). The read beam focused onto the desired site is reflected as a function of the stored information, and the intensity of the reflected beam is detected by a detector in the read/write device 2.

In the storage film 11, the information units are formed by changing the optical properties in a region having a preferred size of less than 1 μm. The information may be stored in binary form; i.e., the local reflectivity adopts only two values at the site of one information unit. In other words, if the reflectivity is above a fixed threshold value, a “1”, for example, is stored at the site in question on the information carrier, and, if it is below this threshold value or below a different, lower threshold value, a “0” is stored correspondingly. It is, however, also conceivable for the information to be stored in a plurality of gray stages. This is possible if the reflectivity of the storage film at the site of an information unit can be altered specifically by defined adjustment of the refractive index without saturation being reached.

FIG. 2 illustrates diagrammatically how in order to prepare the storage film 11 of the data storage medium 1 from FIG. 1 a polymer film is extruded together with an absorber layer disposed on the polymer film.

The extruder used for this purpose has an extruder head 30 with two exit apertures from which a polymer 32 (polypropylene in the example) and an absorber compound 33 (see below) emerge at elevated temperature. Behind the extruder head 30 these two starting materials converge and cool to form two layers, namely the polymer film, labeled 34, and the absorber layer, labeled 35. The polymer film 34 and the absorber layer 35 adhere to one another and form the storage film 11. To put it more precisely, the storage film 11 comes about by biaxial orientation of the extrudate following extrusion. As a result, the polymer film 34 becomes a film of biaxially oriented polypropylene (BOPP), a material in which a high inherent energy is stored (see above).

In one example in connection with FIGS. 1 and 2, the extruder head 30 has a temperature of 120-150° C. The absorber compound 33 used is a mixture of 0.01-0.1% by weight of the absorber dye Sudan Red 7B in acrylate hot melt, i.e., the absorber layer 35 contains the absorber dye Sudan Red 7B embedded in the acrylate hot melt binder. The extrudate is drawn by 500% in the lengthwise direction (i.e., in the direction in which the polymer 32 and the absorber compound 33 emerge from the extruder head 30) and by 700% in the transverse direction. Following biaxial orientation, the polymer film 34 has a thickness of 20-30 μm and the absorber layer 35 has a thickness of 10-20 μm, giving an overall thickness of 30-50 μm for the storage film 11. Depending on embodiment, different production conditions and different compositions and dimensions for the individual layers of the storage film are possible. It is also conceivable for additional layers to be provided.

For the further production of the data storage medium 1, the storage film 11 is provided with an adhesion layer and is wound onto the optically transparent core mentioned earlier on above.

In the case of another possibility for preparing a storage film, the absorber is admixed to the polymer for the polymer film. The storage film is then extruded as a unit comprising polymer film and absorber from the absorber-comprising polymer. In one example a mixture of polypropylene and 0.01-0.1% by weight of the absorber dye Sudan Red 7B is extruded at a temperature of 120-150° C. Thereafter the extrudate is biaxially oriented, specifically by 500% in the lengthwise direction (i.e., in the direction in which the mixture of polymer and absorber dye emerges from the extruder head) and by 700% in the transverse direction. The storage film produced in this way has a thickness of 30-50 μm and an optical density of 0.1-0.3. Depending on embodiment, different production conditions and different mixtures, including mixtures of different polymers or absorber dyes, and also different dimensions are possible. In one variant of this method, an adhesion layer (e.g., comprising an acrylate compound) containing no absorber dye is coextruded together with the storage film.

In other embodiments of the method, the preparation of the storage film involves first extruding a polymer film. Thereafter the absorber is introduced into the polymer film by a diffusion process. Where appropriate, the polymer film or storage film may be drawn before or after the diffusion process is implemented.

In order to implement the diffusion process the polymer film can be placed in a solution comprising the absorber. The solvent should on the one hand dissolve the absorber and on the other hand attack the polymer film to such an extent that it absorbs the solution and swells. In the course of this process, the absorber molecules are distributed within the interior of the polymer film. Thereafter the polymer film is withdrawn from the solution and the solvent is evaporated. The polymer film substantially reacquires its original dimensions, the absorber molecules remaining in the interior of the polymer film.

Another option for a diffusion process consists in first transferring the absorber into the gas phase and exposing the polymer film to a gas comprising the absorber. The absorber molecules diffuse into the interior of the polymer film, and some of the absorber molecules remain there as a result of absorption processes.

A suitable absorber for a polymer film of polypropylene is Disperse Red 1 (DR1). DR1 is an azo dye which is known from applications with dye-containing polymer films (particularly in the field of nonlinear optics). This absorber is introduced into the polymer film preferably by way of a diffusion process. If, on the other hand, the storage film is to be prepared by extrusion in accordance with one of the methods illustrated above, in which temperatures in the order of magnitude of 200° C. occur for polypropylene, absorbers with higher temperature stability, such as anthraquinone dyes or indanthrene dyes, for example, are more suitable than DR1.

The storage film comprises the absorber preferably in an amount or concentration such that one ply of the storage film has an optical density in the range from 0.1 to 0.3. The optical density is a measure of the absorption, in this case related to the light wavelength of a write beam. Depending on specific application, the optical density for one ply of the storage film may alternatively be less than 0.1 or greater than 0.3.

1. A method of producing a data storage medium (1), with an optically writeable and readable information carrier which comprises a polymer film (34) whose refractive index can be altered locally by heating, and with an absorber (35) which is assigned to the polymer film (34) and is set up so as at least partly to absorb a write beam and to transfer the generated heat at least partly, locally, to the polymer film (34), comprising the steps of:
preparing a storage film (11) comprising the polymer film (34) and the absorber (35) assigned to the polymer film (34), and subsequently
adapting the storage film (11) to the geometry provided in the data storage medium (1).

2. The method as claimed in claim 1, characterized in that during preparation of the storage film (11) the polymer film (34) is extruded together with a layer (35) which is disposed on the polymer film (34) and comprises absorber.

3. The method as claimed in claim 1, characterized in that during preparation of the storage film the absorber is admixed to the polymer for the polymer film and in that a unit comprising polymer film and absorber is extruded from the absorber-comprising polymer.

4. The method as claimed in claim 1, characterized in that during preparation of the storage film the polymer film is first extruded and then the absorber is introduced into the polymer film by a diffusion process.

5. The method as claimed in claim 4, characterized in that in the diffusion process the polymer film is swollen in a solution comprising the absorber and then the solvent is evaporated.

6. The method as claimed in claim 4, characterized in that during the diffusion process the absorber is transferred to the gas phase and the polymer film is exposed to a gas which comprises the absorber.

7. The method as claimed in claim 2 or 3, characterized in that during preparation of the storage film (11) the extrudate is biaxially oriented following extrusion.

8. The method as claimed in any of claims 4 to 6, characterized in that the polymer film is biaxially oriented before or after the diffusion process is implemented.

9. The method as claimed in any of claims 1 to 8, characterized in that polypropylene is used as polymer for the polymer film (34).

10. The method as claimed in any of claims 1 to 9, characterized in that at least one of the substances selected from the following list is used as absorber: Disperse Red 1, anthraquinone dyes, indanthrene dyes.

11. The method as claimed in any of claims 1 to 10, characterized in that the storage film (11) is disposed in a plurality of plies (10) through which information can be written to a preselected storage film ply (10) or read from a preselected storage film ply (10).

12. The method as claimed in claim 11, characterized in that a continuous storage film (11) is wound spirally, preferably onto a central, optically transparent core which is disposed to accommodate a read/write device (2) of a drive attuned to the data storage medium (1).

13. The method as claimed in claim 11 or 12, characterized in that between adjacent storage film plies (11) there is disposed an adhesion layer (12) whose refractive index differs preferably only slightly from the refractive index of the storage film (11).
